(19) United States
(12) Patent Application Publication
(10) Pub. No.: US 2010/0189263 A1
(43) Pub. Date: Jul. 29, 2010

(54) METHOD AND APPARATUS FOR GENERATING AND UPDATING SECURITY CODES

(75) Inventors: Joyce E. Cunningham, Hudson, MA (US); Thomas F. Galloway, Upton, MA (US); Wilbert John Janoschka, Ozark, AR (US); Michael John Rochette, Berlin, MA (US)

Correspondence Address: K&L Gates LLP, STATE STREET FINANCIAL CENTER, One Lincoln Street, BOSTON, MA, 02111-2950, US

(73) Assignee: Mustang Microsystems, Inc., Hopkinton, MA (US)

(21) Appl. No.: 12/611,205

(22) Filed: Nov. 3, 2009

Related U.S. Application Data
(60) Provisional application No. 61/111,563, filed on Nov. 5, 2008.

(51) Int. Cl. H04L 9/08; H04L 9/14

(52) U.S. Cl. 380/279; 380/45; 380/278

(57) ABSTRACT

A system and method for creating a target cryptographic key. In one embodiment the system includes a first cryptographic module including a first cryptographic key, and a loader including a second cryptographic key, a communications port for the first cryptographic module; and a communication link for transmitting the target cryptographic key. When the first cryptographic module is connected with the communications port of the loader, the first cryptographic module loads the second cryptographic key and creates the target cryptographic key in response to the first cryptographic key and the second cryptographic key. In one embodiment the method of creating a cryptographic key, includes the steps of: loading a second cryptographic key into a first cryptographic module; calculating, by the first cryptographic module, a target cryptographic key in response to a first cryptographic key and a second cryptographic key; and loading the target cryptographic key to a loader.

### CROSS REFERENCE TO RELATED APPLICATIONS

This application claims the benefit under 35 U.S.C. §119(e) to U.S. Provisional Application No. 61/111,563, filed Nov. 5, 2008, the entire disclosures of which are hereby incorporated herein by reference for all purposes.

### FIELD OF THE INVENTION

The invention relates generally to the field of encryption and more specifically to the field of generating and updating encryption keys used in other devices.

### BACKGROUND OF THE INVENTION

The Derived Unique Key Per Transaction (DUKPT) method of encryption key loading uses a single master encryption key from which all other terminal keys are “derived”. This method is suitable for use with various encryption keys such as those formed using standards such as the Triple Data Encryption Standard (TDES) or the Advanced Encryption Standard (AES). This master or base key is known as the Base Derivation Key (BDK). The security of this base key is critical. The base key is typically never outside of a Tamper Resistant Security Module (TRSM), except as a TDES cryptogram.

To date, special procedures and custom built key loading equipment are used to upgrade encryption keys such as debit keys used within the terminals present in retail stores. One upgrade process updates keys in a specific type of target device, such as a PIN (Personal Identification Number) Entry Device (PED), and loads keys according to the DUKPT method based on one or a set of Base Derivation Keys (BDKs). Only the specifically pre-set target devices, PEDs or terminals can receive a key. The target devices are typically taken to a secure location outside of the retail establishment where the key is loaded.

This movement of the target devices, PEDs or other secure terminals to a secure cryptographic facility for the purpose of changing encryption keys is costly and inefficient. The present invention addresses this issue.

### SUMMARY OF THE INVENTION

The invention relates to a system and method for creating a target cryptographic key. In one embodiment the target cryptographic key is an initial key or IK. In one embodiment, the system for creating a target cryptographic key includes a removable cryptographic module including a first cryptographic key, and a loader including a second cryptographic key, a communications port for communicating with the removable cryptographic module, and a communication link for transmitting the target cryptographic key, wherein when the removable cryptographic module is connected with the communications port of the loader, the removable cryptographic module loads the second cryptographic key and creates the target cryptographic key, in response to the first cryptographic key and the second cryptographic key. In one embodiment, the first cryptographic key is a key encryption key or KEK. In another embodiment, the second cryptographic key is an encrypted base derivation key or eBDK. In one embodiment, the target cryptographic key is an IK. In another embodiment, the target cryptographic key is loaded from the removable cryptographic module to the loader. In another embodiment, the target cryptographic key is transmitted on the communication link from the loader to the target device. In yet another embodiment, the second cryptographic key is stored encrypted in the loader. In still yet another embodiment, the system further comprises a key serial number. In another embodiment, the target cryptographic key is the encrypted key serial number.

Another aspect of the invention is a method of creating a target cryptographic key in a system having a removable cryptographic module. The system includes a first cryptographic key and a loader having a second cryptographic key. In one embodiment, the method includes the steps of: loading the second cryptographic key into the removable cryptographic module from the loader; creating, by the removable cryptographic module, a target cryptographic key in response to the first cryptographic key and the second cryptographic key; and loading the target cryptographic key to the loader. In another embodiment, the method further includes the step transmitting by the loader the encrypted cryptographic key to a target device on a communication link. In another embodiment, the second cryptographic key is stored in the loader in encrypted form and the method further includes the step of decrypting, by the removable cryptographic module, the second cryptographic key. In yet another embodiment, the method further includes the step of using the decrypted second cryptographic key to encrypt a key serial number to create the target cryptographic key.

In another aspect, the invention relates to a system for creating a target cryptographic key. The system includes a removable cryptographic module, and a loader including an internal IC card. The internal IC card includes an internal IC card memory including a first cryptographic key. The loader includes a communications port for the removable cryptographic module; and a communication link for transmitting a target cryptographic key. The removable cryptographic module includes a second cryptographic key and when the removable cryptographic module is connected with the removable cryptographic module communications port of the loader, the removable cryptographic module transmits the second cryptographic key to the loader and the loader creates a target cryptographic key in response to the first cryptographic key and the second cryptographic key. In another embodiment, the target cryptographic key is transmitted on the communication link from the loader to the target device. In another embodiment, the second cryptographic key is stored encrypted in the removable cryptographic module. In yet another embodiment, the system further comprises a key serial number. In still yet another embodiment, the target cryptographic key is the encrypted key serial number. In another embodiment, the loader further includes a loader processor and a loader memory and the internal IC card is in communications with the loader processor.

In another aspect, the invention relates to a method of creating a target cryptographic key in a system including a loader having an internal IC card having a first cryptographic key, and a removable cryptographic module having a second cryptographic key. The method includes the steps of: loading the second cryptographic key from the removable cryptographic module to the loader; and creating, by the loader, a target cryptographic key in response to the first cryptographic key and the second cryptographic key. In one embodiment, the method further includes the step transmitting by the loader the cryptographic key to a target device on a communication link. In another embodiment, the second cryptographic key is stored in the removable cryptographic module in encrypted form and the loader further includes an internal IC card includes the first cryptographic key. The method further includes the step of decrypting, by the internal IC card, the second cryptographic key using the first cryptographic key. In yet another embodiment, the method includes the step of using the decrypted second cryptographic key to encrypt a key serial number to create the target cryptographic key.

### BRIEF DESCRIPTION OF THE DRAWINGS

The invention is pointed out with particularity in the appended claims. The advantages of the invention described above, together with further advantages, may be better understood by referring to the following description taken in conjunction with the accompanying drawings. In the drawings, like reference characters generally refer to the same parts throughout the different views. The drawings are not necessarily to scale, emphasis instead generally being placed upon illustrating the principles of the invention.

FIG. 1 is a block diagram of an embodiment of the system of the invention;

FIG. 1A is a diagram of the embodiment of data structures utilized in communicating between the loader and the target device in the system of FIG. 1;

FIG. 1B is a flow diagram depicting the operation of the system of FIG. 1;

FIG. 2 is a block diagram of another embodiment of the system of the invention;

FIG. 2A is a flow diagram depicting the operation of the system of FIG. 2;

FIG. 3 is a block diagram of yet an embodiment of the system of the invention;

FIG. 3A is a flow diagram depicting the operation of the system of FIG. 3;

FIG. 4 is a block diagram of still yet another embodiment of the system;

FIG. 4A is a flow diagram depicting the operation of the system of FIG. 4;

FIG. 5 is a block diagram of an embodiment of the loader portion of the embodiment of the system of the invention shown in FIGS. 1, 2 and 3; and

FIG. 6 is a block diagram of an embodiment of the smart card portion of the embodiment of the system of the invention shown in FIGS. 1, 2, 3, and 4.

### DESCRIPTION OF THE PREFERRED EMBODIMENT

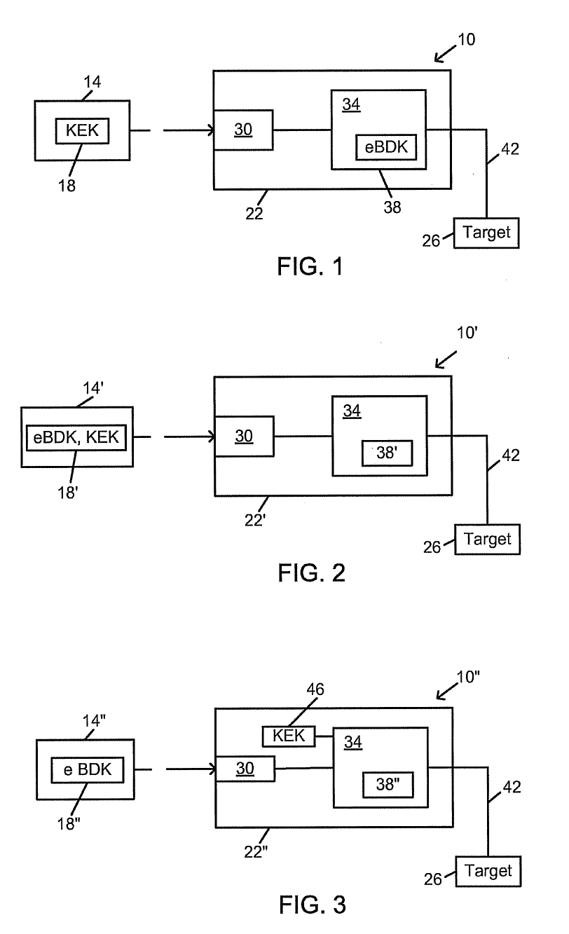

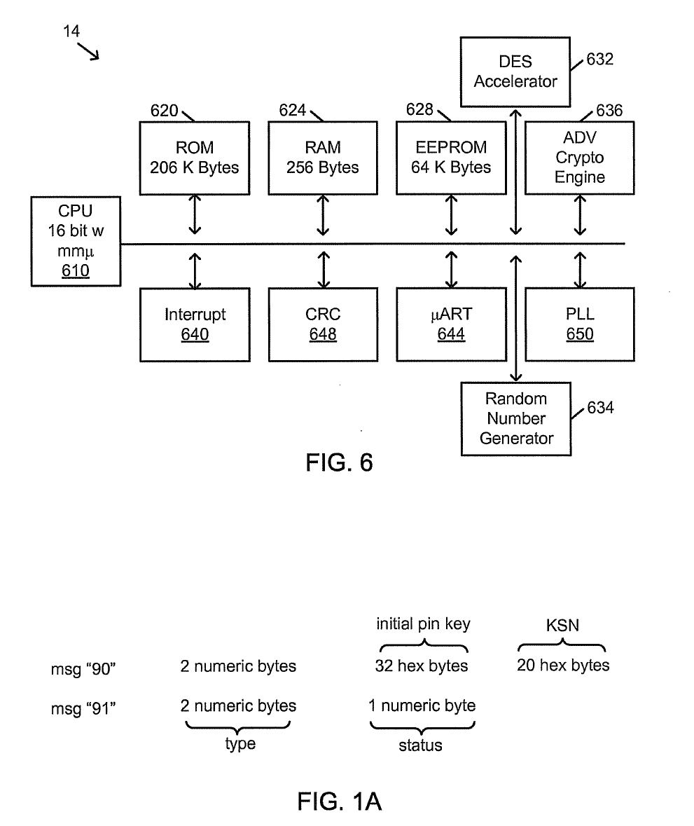

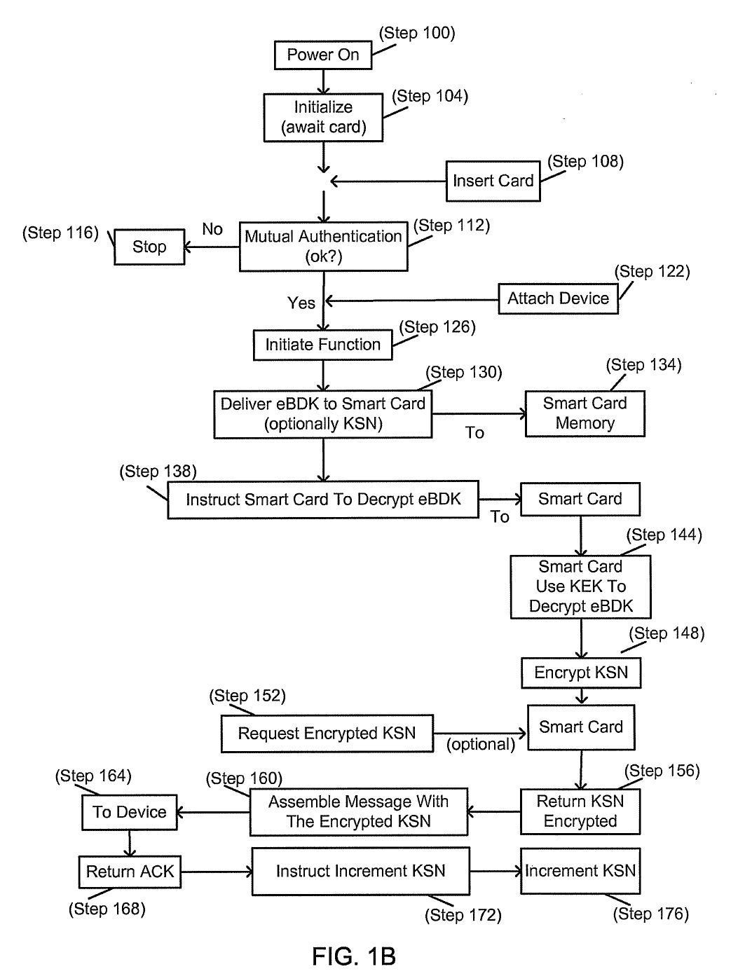

In brief overview and referring to FIG. 1, an embodiment of a system 10 constructed in accordance with the present invention includes a removable cryptographic module 14. In one embodiment the removable cryptographic module 14 is in a form format such as a smart card. Such a removable cryptographic module 14, referred to herein generically as a smart card, includes a smart card processor and a smart card memory 18 holding a first encryption key such as a key encryption key (KEK) and an encryption parameter such as key serial number (KSN); a loader 22 and a target device 26. The target device may be, but is not limited to, a Personal Identification Number Entry Device (PED), a PIN-pad, a security terminal or any suitable device that requires a new cryptographic key to process data securely. In general, the cryptographic result of some of the exemplary processes described herein is to load a new cryptographic key initial key or IK into a PED or target device.

The processes described herein make use of a number of cryptographic keys. The key encryption key, or KEK, is an encryption key that is used to protect the base derivation key or BDK. In one embodiment, the base derivation key or BDK is a secret key, which is the “seed” key from which all initial keys or IKs are created. Using the Data Encryption Algorithm (DEA), the KEK produces the encrypted Base Derivation Key (eBDK) from the BDK, and also is used to obtain the BDK from the eBDK in a “decrypting” process. The eBDK, as an encrypted form of the base derivation key or BDK, can be stored and handled outside of security enclosures.

In one embodiment, the encryption parameter is a key serial number or KSN and is a 20 hex character structured number which is encrypted by the BDK to produce the initial key or IK. In one embodiment, the initial key or IK is the actual data that is loaded into the target device or PED and which begins the process of key creation within the target device or PED. The key serial number or KSN is also communicated to the target device or PED with the IK. The KSN is incremented each time a new IK is created. This process places a different (but related) IK in each target device or PED. In another embodiment any number may be used instead of key serial number.

Returning to the figure, the loader 22 includes a smart card reader 30, a loader processor 34, and a loader memory 38. The loader memory 38 holds an encrypted base derivation key (eBDK). The target device 26, such as a PIN Entry Device (PED) or personal identification number pad or PIN-pad, is connected to the loader 22 by a communications link 42 such as an RS-232 serial line. This embodiment provides the functions of a fully secure key loader that can operate outside of a secure cryptographic environment. It is specifically configured for each project, prepared with only one set of BDKs and one unique KEK, and intended to load specific terminal types.

In use, the smart card 14 is inserted into the smart card reader 30 and the eBDK in loader memory 38 is read into the smart card memory 18. The smart card processor then uses the KEK to decrypt the eBDK into a clear text base derivation key (BDK). The smart card processor then uses the BDK to encrypt the KSN, which produces the desired initial key IK for the target device.

The initial key is then downloaded through the smart card reader 30 to the loader processor 34, along with the KSN and transmitted to the target device 26 through the communications link 42. Once the target device 26 has been loaded with the initial key, the previous KSN is incremented within the smart card 14. Although discussed in terms of an RS-232 serial link the communications link can be any communications link compatible with the target device. Note also that although the smart card or removable cryptographic module 14 is described in terms of a removable device, it may also be attached permanently with the loader.

Referring to FIG. 1A, the transmission of data between the loader 22 and the target device 26 makes use of the VISA standard format. In one embodiment, the basis of the current standard format is described in Visa International, Inc.'s standard “PIN Processing and Data Authentication, August 1988, sec. 3.2.4; Key Loading Device to Pin Pad Message Formats” incorporated herein by reference. For example, two of the message types are “message type 90” which loads the initial key request and “message type 91” which responds to the request. Message type 90 has two bytes to designate the numeric message type (in this case “90”), 32 hexadecimal (4 bit) characters to carry the initial key, and twenty hexadecimal (4 bit) characters to carry the key serial number (KSN). The proper response message type is “91” and has 2 numeric bytes for the message type (in this case “91”) and 1 numeric byte (“1” or “0”) for the confirmation status. Although this embodiment has been described in terms of the Visa standard and its derivatives, one skilled in the art will realize any security standard may be used.

In more detail and referring to FIG. 1B, the operation of the embodiment of the system shown in FIG. 1 begins with the powering on of the switched power supply 80 by using a “Medeco” type key 84 (Medeco Security Locks, Salem, Va.) (Step 100). This causes the processor 34 to boot and initialize. (Step 104) The smart card 14 is then placed into the smart card reader 30 (Step 108) and the loader 22 and the smart card 14 authenticate each other (Step 112). This is achieved by the mutual exchange and confirmation of secret codes. If the mutual authentication fails, the process stops (Step 116). If the mutual authentication is successful, the loader 22 displays a “ready” message, and a target device 26 is attached to the communications link 42 (Step 122). The system is then instructed by the user to initiate its function using a second Medeco key (Step 126) and the loader 22 delivers (Step 130) the eBDK and optionally in a second embodiment the KSN to the smart card 14.

The loader 22 then instructs the smart card 14 to decrypt the eBDK (Step 138), and the smart card 14 uses the KEK to decrypt the eBDK to obtain the BDK (Step 144). The smart card 14 then uses the BDK to encrypt the KSN to form the encryption key (Step 148). In one embodiment, the target encryption key is the initial key (IK). The loader 22 requests the encryption key (Step 152) and the smart card 14 returns the encryption key (Step 156) to the loader 22.

The loader 22 next assembles a message for the target device 26 that contains the encryption key (in one embodiment an IK) and the KSN (Step 160) and sends the message over the communication link 42 to the target device 26 (Step 164). Upon receipt of the encryption key by the target device 26, the target device 26 acknowledges the receipt of the key to the loader 22 (Step 168) and the loader 22 on receiving the acknowledgement instructs the smart card to increment the KSN (Step 172). The KSN is then incremented by the smart card 14 (Step 176) for updating the next target device 26. In various embodiments the target encryption key is encrypted prior to transmission to the target.

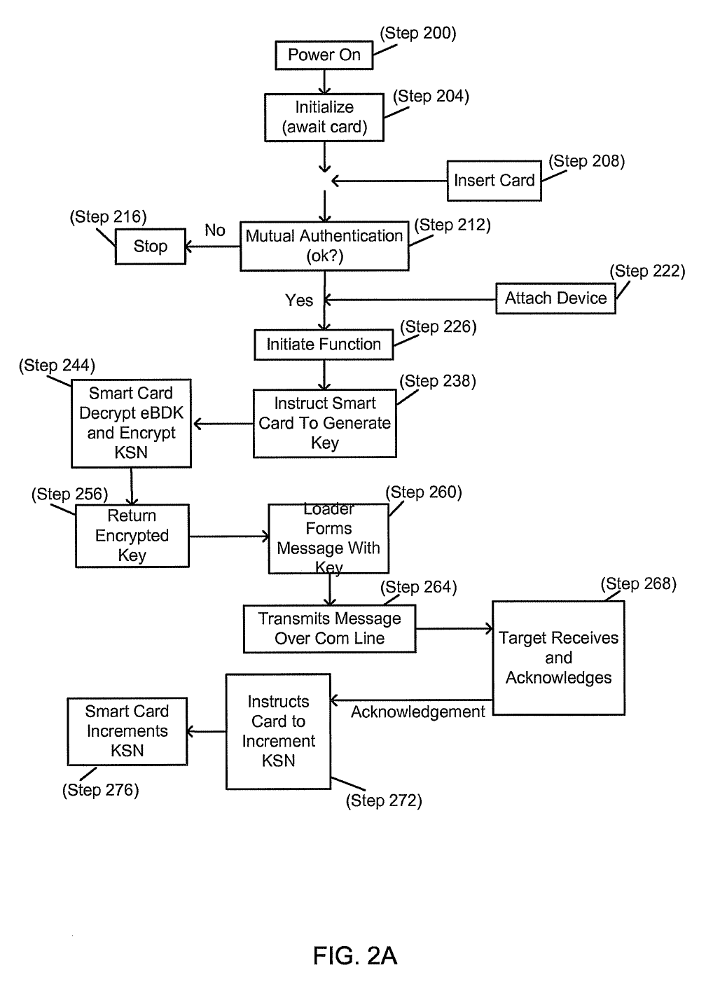

Again in brief overview and referring to FIG. 2, another embodiment of a system 10′ constructed in accordance with the present invention includes a smart card 14′ having a smart card processor, a smart card memory 18′ holding a key encryption key (KEK), an encrypted base derivation key (eBDK) and a key serial number (KSN); a loader 22′ and a target device 26. The loader includes a smart card reader 30, a loader processor 34, and a loader memory 38′. The target device 26 is connected to the loader 22 by a communications link 42 such as an RS-232 serial line.

In use, the smart card 14′ is inserted into the smart card reader 30 and after authentication of the loader and the smart card; the smart card processor decrypts the eBDK and then uses the clear text BDK in smart card memory 18′ to encrypt the KSN. The encrypted KSN is then down loaded through the smart card reader 30 to the loader processor 34 and transmitted to the target device 26 through the communications link 42. Once the target device 26 has been loaded with the encrypted KSN, the previous KSN is incremented either in the smart card 14′ or the loader 22′.

In more detail and referring to FIG. 2A, the operation of the system shown in FIG. 2 begins with the powering on of the power supply 80 by using key 84 (Step 200). This causes the processor 34′ to boot and initialize (Step 204). The smart card 14′ is then placed into the smart card reader 30 (Step 208) and the loader 22′ and the smart card 14′ authenticate each other (Step 212). This is achieved by using an exchange of unique secret codes. If the mutual authentication fails the process stops (Step 216). If the mutual authentication is successful, the target device 26 is attached to the communications link 42 (Step 222). The system is then instructed by the user to initiate its function (Step 226), again using a physical key.

The loader 22′ then instructs the smart card 14′ to decrypt the eBDK (Step 238), and the smart card 14′ uses the KEK stored in its memory to decrypt the eBDK to obtain the BDK and uses the resulting BDK to encrypt the KSN to form the encryption key (Step 244). In one embodiment, the target encryption key is the IK. The loader 22′ requests the target encryption key and the smart card 14′ returns the encryption key (Step 256) to the loader 22′.

The loader 22′ assembles a message for the target device 26 with the encryption key (Step 260) and sends the message over the communication link 42 to the target device 26 (Step 264). Upon receipt of the target encryption key by the target device 26, the target device 26 acknowledges the receipt of the key to the loader 22′ (Step 268) and the loader 22 on receiving the acknowledgement instructs the smart card to increment the KSN (Step 272). The KSN is then incremented by the smart card 14′ (Step 276) for updating the next target device 26.

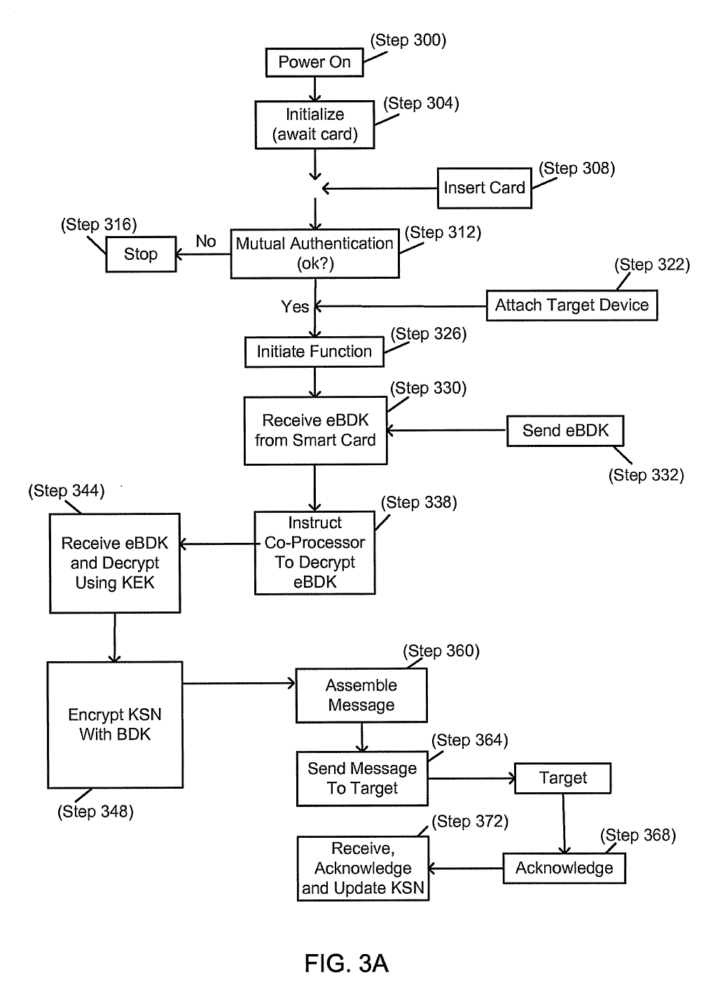

In yet another embodiment, in brief overview and referring to FIG. 3, a system 10″ constructed in accordance with the present invention includes a smartcard 14″ having a smart card processor, and a smart card memory 18″ holding an encrypted base derivation key (eBDK); a loader 22″ and a target device 26. The loader includes a smart card reader 30, a loader processor 34, an internal cryptographic module 46 and a loader memory 38″. The target device 26 is again connected to the loader 22 by a communications link 42 such as an RS-232 serial line.

In use, the smart card 14″ is inserted into the smart card reader 30 and the eBDK is then down loaded through the smart card reader 30 to the loader processor 34 and into the internal cryptographic module 46. The internal cryptographic module 46 decrypts the eBDK then encrypts the KSN with the clear text BDK and the resulting initial key along with the clear text KSN is transmitted to the target device 26 through the communications link 42. Once the target device 26 has been loaded with the encrypted KSN the previous KSN is incremented.

In more detail and referring to FIG. 3A, the operation of the system shown in FIG. 3, begins with the powering on of the power supply 80 by using key 84 (Step 300). This causes the processor 34″ to boot and initialize. (Step 304) The smart card 14″ is then placed into the smart card reader 30 (Step 308) and the loader 22″ and the smart card 14″ authenticate each other. (Step 312) This authentication is performed using an exchange of unique secret codes. If the mutual authentication fails, the process stops (Step 316). If the mutual authentication is successful, the target device 26 is attached to the communications link 42 (Step 322). The system is then instructed by the user to initiate its function (Step 326) and the loader 22″ receives (Step 330) the eBDK from the smart card 14″ (Step 332).

The loader 22″ then delivers the eBDK to the internal cryptographic module 46 and instructs the internal cryptographic module 46 to decrypt the eBDK (Step 338), and the internal cryptographic module 46 uses the KEK it has stored in its local memory to decrypt the eBDK to obtain the BDK (Step 344). The internal cryptographic module 46 then uses the BDK to encrypt the KSN to form the encryption key (Step 348). In one embodiment the target encryption key is an IK. In one embodiment, the internal cryptographic module 46 is a smart card and reader in communication with the loader processor 34 through a UART.

The loader 22″ assembles a message for the target device 26 with the encryption key (Step 360) and sends the message over the communication link 42 to the target device 26 (Step 364). Upon receipt of the target encryption key by the target device 26, the target device 26 acknowledges the receipt of the key to the loader 22″ (Step 368) and the loader 22 on receiving the acknowledgement increments the KSN (Step 372) for updating the next target device 26.

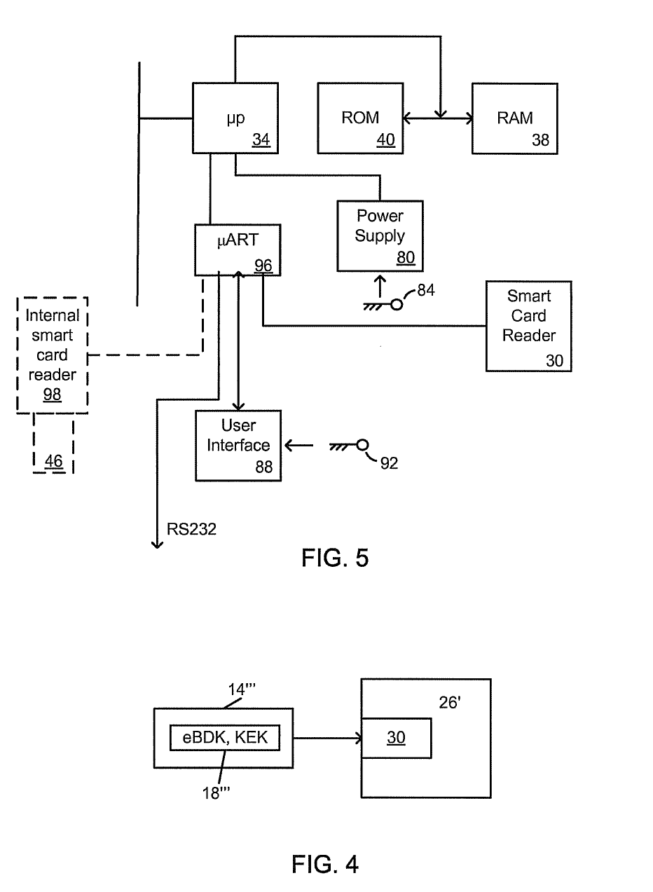

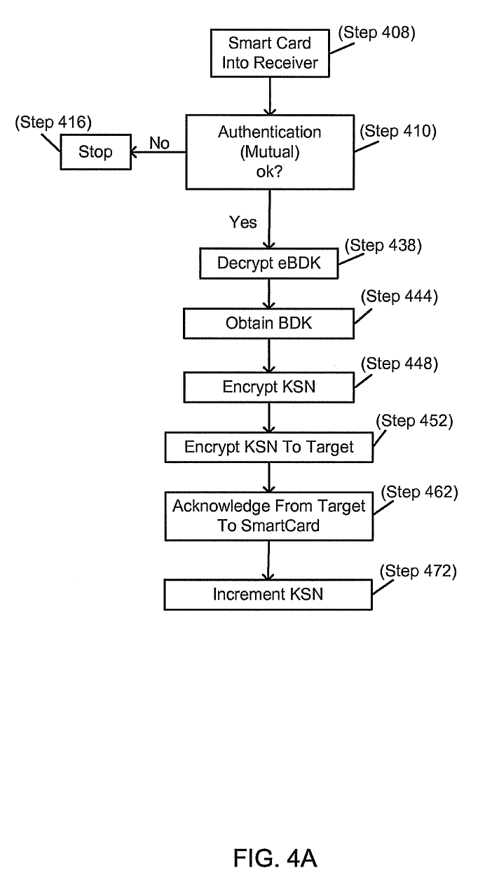

In still yet another embodiment, in brief overview and referring to FIG. 4, a smart card 14′″ includes an eBDK, KSN and KEK in memory 18′. When inserted into a target device 26′ having a card smart card reader 30, the engagement of the smart card 14′″ with the smart card reader 30 causes the smart card 14′″ to decrypt the eBDK to form a clear text BDK. The smart card then encrypts the KSN with the BDK and loads the resulting target encryption key into the target device 26′. When the target encryption key is loaded, the smart card 14 increments the KSN, and the smart card 14 can be removed.

In more detail and referring to FIG. 4A, the operation of the system shown in FIG. 4, begins with the smart card 14′″ being placed into the smart card reader 30 (Step 408) of the target device 26′ and the target device 26′ and the smart card 14′″ authenticate each other (Step 410). If the mutual authentication fails the process stops (Step 416). If the mutual authentication is successful (Step 418), the system then initiates its function (Step 426) beginning with the smart card 14′ decrypting the eBDK (Step 438) by using the KEK stored in its memory to decrypt the eBDK to obtain the BDK (Step 444). The smart card 14′″ then uses the BDK to encrypt the KSN to form the encryption key (Step 448) which is then delivered (Step 452) to the target device 26′. Upon receipt of the target encryption key by the target device 26′, the target device 26′ acknowledges the receipt of the key to smart card 14′ which then increments the KSN (Step 472) for updating the next target device 26.

Referring to FIG. 5, in more detail, an embodiment of the loader portion 22, 22′ (generally 22) of the system 10 of FIGS. 1 and 2 is shown in more detail. In this embodiment the loader 22 includes a loader processor 34, 34′ (generally 34) with a RAM memory 38, 38′ (generally 38) and a ROM memory 40. The ROM memory 40 is used to hold the BIOS as well as the operating system and any permanent data, such as the eBDK. The RAM 38 memory is used to hold transient data such as the target encryption key. One input into the processor 34 is provided by the smart card reader 30, which interfaces with smart card 14, 14′ (generally 14). Another input into the processor is through the user interface 88 which is enabled by a key switch 92. Power to the system is produced using a switched power supply 80 which is activated by a key 84. In the embodiment shown, the I/O ports of the device are implemented through a UART 96.

In one embodiment the loader 22 is constructed from a single board computer such as the Prometheus ZFx86 PC/104 CPU by Diamond Systems Corporation, Mountainview Calif. In one embodiment the processor 34 uses the Linux operating system. Other computers and operating systems may be used.

In one embodiment (FIG. 6) the smart card 14 includes a 16 bit CPU with memory management unit and 206 Kbyte ROM (Read Only Memory) 620, 256 byte RAM (Random Access Memory) 624, and 64K byte EEPROM (Electrically Erasable Programmable ROM) memories 628. The smart card 14 includes a combination DES (Digital Encryption Standard) Accelerator and Electronic Code Book 632, a Random Number Generator 634 and a Cryptographic engine 636 for encryption functions. Communications with the smart card 14 is handled through an interrupt circuit 640, a UART 644, and a CRC 648 (Cyclic Redundancy Check) circuit. The smart card 14 also includes a phase locked loop 650 for timing. An example of such a smart card 14 is the SLE 66CX642P Security and Chip Card ICs of Infineon Technologies AG, Munich, Germany. In this embodiment the BDK cryptogram, the KEK, and the operating system for the card is stored in EEPROM 628. The clear text BDK is stored in RAM 624 after creation and the RAM 624 is cleared each time the card is removed from the loader 10.

In use in the field, for the embodiment for example shown in FIG. 1, the BDK cryptogram is housed within a Tamper-Evident Loader 22, and the Key Encrypting Key (KEK) that can decrypt is only available for decryption when inserted into the loader 22 on a secure smart card 14. The loader 22 is enclosed within a Tamper-Evident metal housing with several security features. This housing provides evidence that the loader 22 has not been compromised. The security features include serialized metal seals, and the transportation of the loader 22 in a “TEA” bag Serialized Security Envelope—that cannot be opened without obvious damage to the envelope. The abbreviation “TEA” refers to a “Tamper Evident and Authenticable” enclosure, usually a plastic bag with a unique number that cannot be opened without making such a security violation apparent. Again, the loader 22 requires two unique metal keys (for example Medeco type keys to operate, (power and interface keys, 84 and 92 respectively) each held by two “trusted” individuals.

Loaders 22 to be used to update the target devices 26 (for example PIN Entry Devices (PEDs)) in a store are delivered to the store site in sealed bags with unique serial numbers. The bags are only opened in the presence of a number of individuals including preferably in the presence of the store manager in charge. On arrival of the security technician at the store and introduction to the responsible personnel, a location in the facility is chosen in which the loader 22 can be operated securely, out of reach for non-authorized individuals. Preferred areas are where others are working, such as the cash office, or customer service area, but not a generally public location. The PEDs 26 are brought to the loader as they are removed from the points of sale locations, and the sequence of removal is with the manager's approval and direction. The PEDs 26 are connected to the loader 22 through the communications link 42. After the smartcard 14 is inserted into the loader 22, the key is loaded into the PED 26. A display then shows when the PED 26 has been successfully re-keyed. The PED 26 is then detached, a label attached, and the unit is returned to the proper Point of Sale location. When all the PEDs 26 terminals have been re-keyed, the loader 22 is repackaged within a new TEA bag, a security log is updated, and the work is signed off by store management.

While the present invention has been described in terms of certain exemplary preferred embodiments, it will be readily understood and appreciated by one of ordinary skill in the art that it is not so limited, and that many additions, deletions and modifications to the preferred embodiments may be made within the scope of the invention as hereinafter claimed. Accordingly, the scope of the invention is limited only by the scope of the appended claims.

What is claimed is:

1. A system for creating a target cryptographic key comprising:
a first cryptographic module comprising;
a first cryptographic key; and
a loader comprising
a second cryptographic key; and
a communications port for the first cryptographic module,
wherein when the first cryptographic module is connected with the communications port of the loader, the first cryptographic module loads the second cryptographic key and creates the target cryptographic key in response to the first cryptographic key and the second cryptographic key.

2. The system of claim 1 wherein the target cryptographic key is loaded from the first cryptographic module to the loader.

3. The system of claim 1 further comprising a communication link for transmitting the target cryptographic key.

4. The system of claim 3 wherein the target cryptographic key is transmitted on the communication link from the loader to the target device.

5. The system of claim 1 wherein the second cryptographic key is stored encrypted in the loader.

6. The system of claim 1 wherein the system further comprises a key serial number.

7. The system of claim 6 wherein the target cryptographic key is the encrypted key serial number.

8. A method of updating a cryptographic key in a system having a smart card comprising a first cryptographic key and a loader having a second cryptographic key, the method comprising the steps of:
loading the second cryptographic key into the first cryptographic module from the loader;
creating, by the first cryptographic module, a target cryptographic key in response to the first cryptographic key and the second cryptographic key; and
loading the target cryptographic key to the loader.

9. The method of claim 8 further comprising the step transmitting by the loader the target cryptographic key to a target device on a communication link.

10. The method of claim 8 wherein the second cryptographic key is stored in the loader in encrypted form and the method further comprises the step of decrypting, by the first cryptographic module, the second cryptographic key.

11. The method of claim 10 further comprising the step of using the decrypted second cryptographic key to encrypt a key serial number to create the target cryptographic key.

12. A system for creating an updated cryptographic key comprising:
a first cryptographic module; and
a loader comprising:
an internal cryptographic module, the internal cryptographic module comprising an internal cryptographic module memory comprising a first cryptographic key; and
a communications port for the first cryptographic module,
wherein the first cryptographic module comprises a second cryptographic key and when the first cryptographic module is connected with the first cryptographic module communications port of the loader, the first cryptographic module transmits the second cryptographic key to the loader and the loader creates a target cryptographic key in response to the first cryptographic key and the second cryptographic key.

13. The system of claim 12 further comprising a communication link for transmitting the target cryptographic key.

14. The system of claim 13 wherein the target cryptographic key is transmitted on the communication link from the loader to the target device.

15. The system of claim 12 wherein the second cryptographic key is stored encrypted in the first cryptographic module.

16. The system of claim 12 wherein the system further comprises a key serial number.

17. The system of claim 16 wherein the target cryptographic key is the encrypted key serial number.

18. The system of claim 12 wherein the loader further comprises a loader processor and a loader memory and the internal cryptographic module is in communications with the loader processor.

19. A method of creating a cryptographic key in a system comprising a loader comprising an internal cryptographic module having a first cryptographic key, and a first cryptographic module having a second cryptographic key, the method comprising the steps of:
loading the second cryptographic key from the first cryptographic module to the loader; and
creating, by the loader, a target cryptographic key in response to the first cryptographic key and the second cryptographic key.

20. The method of claim 19 further comprising the step transmitting by the loader the target cryptographic key to a target device on a communication link.

21. The method of claim 19 wherein the target cryptographic key is encrypted.

22. The method of claim 19 wherein the second cryptographic key is stored in the first cryptographic module in encrypted form; wherein the loader further comprises an internal cryptographic module comprising the first cryptographic key; and wherein the method further comprises the step of decrypting, by the internal cryptographic module, the second cryptographic key using the first cryptographic key.

23. The method of claim 22 further comprising the step of using the decrypted second cryptographic key to encrypt a key serial number to create the target cryptographic key.

24. A system for creating a target cryptographic key comprising:
a first cryptographic module comprising;
a first cryptographic key and a second cryptographic key; and
a key recipient comprising
a communications port for the first cryptographic module,
wherein when the first cryptographic module is connected with the communications port of the key recipient, the first cryptographic module creates the target cryptographic key in response to the first cryptographic key and the second cryptographic key and loads it into the key recipient.

25. The system of claim 24 further comprising a target communication link for transmitting a target cryptographic key.

26. The system of claim 25 wherein the target cryptographic key is transmitted on the target communication link from the key recipient to the target device.

27. The system of claim 24 wherein the target cryptographic key is the encrypted key serial number.

28. A method of target cryptographic key in a system having a first cryptographic module comprising a first cryptographic key and second cryptographic key, and a key recipient, the method comprising the steps of:
creating, by the first cryptographic module, a target cryptographic key in response to the first cryptographic key and the second cryptographic key; and
loading the target cryptographic key to the key recipient.

29. The method of claim 28 further comprising the step transmitting by the key recipient the encrypted cryptographic key to a target device on a target communication link.

30. The method of claim 28 further comprising the step of using the first cryptographic key to encrypt a second cryptographic key to create the target cryptographic key.
